(19) United States
(12) Patent Application Publication
(10) Pub. No.: US 2014/0141928 A1
(43) Pub. Date: May 22, 2014

(54) PLANETARY GEAR TRAIN OF AUTOMATIC TRANSMISSION FOR VEHICLE

(71) Applicant: Hyundai Motor Company, Seoul (KR)

(72) Inventors: Chang Wook LEE, Suwon-si (KR); Kangsoo Seo, Yongin-si (KR); Jae Chang Kook, Hwaseong-si (KR); Jongsool Park, Hwaseong-si (KR); Myonghoon Noh, Seongnam-si (KR)

(73) Assignee: Hyundai Motor Company, Seoul (KR)

(21) Appl. No.: 13/949,839

(22) Filed: Jul. 24, 2013

(30) Foreign Application Priority Data
Nov. 21, 2012 (KR) 10-2012-0132516

(51) Int. Cl. F16H 3/44

(52) U.S. Cl. CPC F16H 3/44
USPC 475/284; 475/271

(57) ABSTRACT

A planetary gear train of an automatic transmission may include a first shaft receiving engine torque, a second shaft parallel with the first shaft at a predetermined distance, a compound planetary gear set on the second shaft including a first rotation element connected to the first shaft through two paths and operated as a selective fixed element, a second rotation element connected to the first shaft through one path and operated as a selective fixed element, a third rotation element operated as an output element, and a fourth rotation element connected to the first shaft through one path, two transfer gears at connecting portions between the rotation elements of the compound planetary gear set and the first shaft, and frictional elements connecting the first, second, and fourth rotation elements to the first shaft and brakes connecting the first and second rotation elements to a transmission housing.

### CROSS-REFERENCE TO RELATED APPLICATION

The present application claims priority of Korean Patent Application Number 10-2012-0132516, filed Nov. 21, 2012, the entire contents of which application are incorporated herein for all purposes by this reference.

### BACKGROUND OF INVENTION

1. Field of Invention

The present invention relates to an automatic transmission for a vehicle. More particularly, the present invention relates to a planetary gear train of an automatic transmission for a vehicle that can improve mountability and power delivery performance and reduce fuel consumption.

2. Description of Related Art

Recently, vehicle makers direct all their strength to improve fuel economy due to worldwide high oil prices and strengthen of exhaust gas regulations.

Improvement of fuel economy may be achieved by multi-shift mechanism realizing greater number of shift speeds in an automatic transmission. Typically, a planetary gear train is realized by combining a plurality of planetary gear sets and friction elements.

It is well known that when a planetary gear train realizes a greater number of shift speeds, speed ratios of the planetary gear train can be more optimally designed, and therefore a vehicle can have economical fuel mileage and better performance. For that reason, the planetary gear train that is able to realize more shift speeds is under continuous investigation.

Though achieving the same number of speeds, the planetary gear train has a different operating mechanism according to a connection between rotation elements (i.e., sun gear, planet carrier, and ring gear). In addition, the planetary gear train has different features such a durability, power delivery efficiency, and size depend on the layout thereof. Therefore, designs for a combining structure of a gear train are also under continuous investigation.

If the number of shift-speeds, however, increases, the number of components in the automatic transmission also increases. Therefore, mountability, cost, weight and power delivery efficiency may be deteriorated.

Particularly, since the planetary gear train having a number of components is hard to be mounted in a front wheel drive vehicle, researches for minimizing the number of components have been developed.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present disclosure has been made in an effort to provide a planetary gear train of an automatic transmission for a vehicle having advantages of improving mountability by minimizing a length thereof and the number of components as a consequence of achieving eight forward speeds and two reverse speeds by connecting rotation elements of one compound planetary gear set to a first shaft being an input shaft through a plurality of externally-meshed gears.

In addition, the present disclosure has been made in an effort to provide a planetary gear train of an automatic transmission for a vehicle having further advantages of enabling of setting optimum gear ratios due to ease of changing gear ratios by using a plurality of externally-meshed gears, and accordingly improving power delivery performance and fuel economy.

In addition, the present disclosure has been made in an effort to provide a planetary gear train of an automatic transmission for a vehicle having further advantages of improving performance in reverse speeds by achieving two reverse speeds.

A planetary gear train of an automatic transmission for a vehicle according to various aspects of the present disclosure may include: a first shaft receiving a torque of an engine a second shaft disposed substantially in parallel with the first shaft at a predetermined distance; a compound planetary gear set disposed on the second shaft, and including a first rotation element selectively connected to the first shaft through two paths and operated as a first selective fixed element, a second rotation element selectively connected to the first shaft through one path and operated as a second selective fixed element, a third rotation element operated as an output element, and a fourth rotation element selectively connected to the first shaft through one path; two transfer gears interposed at connecting portions between the rotation elements of the compound planetary gear set and the first shaft; and frictional elements including clutches selectively connecting the first, second, and fourth rotation elements to the first shaft and brakes selectively connecting the first and second rotation elements to a transmission housing.

The two transfer gears may include a first transfer gear connecting the first shaft to the first rotation element and the fourth rotation element, and a second transfer gear connecting the first shaft to the first rotation element and the second rotation element.

The frictional elements may include: a first clutch disposed between the first transfer gear and the fourth rotation element; a second clutch disposed between the first transfer gear and the first rotation element; a third clutch disposed between the second transfer gear and the first rotation element; a fourth clutch disposed between the second transfer gear and the second rotation element; a first brake disposed between the second rotation element and the transmission housing; and a second brake disposed between the first rotation element and the transmission housing.

A first forward speed may be achieved by operating the first clutch and the first brake, a second forward speed may be achieved by operating the first clutch and the second brake, a third forward speed may be achieved by operating the first clutch and the second clutch, a fourth forward speed may be achieved by operating the first clutch and the third clutch, a fifth forward speed may be achieved by operating the first clutch and the fourth clutch, a sixth forward speed may be achieved by operating the third clutch and the fourth clutch, a seventh forward speed may be achieved by operating the second clutch and the fourth clutch, an eighth forward speed may be achieved by operating the fourth clutch and the second brake, a first reverse speed may be achieved by operating the second clutch and the first brake, and a second reverse speed may be achieved by operating the third clutch and the first brake.

An exemplary compound planetary gear set may be formed by combining a first planetary gear set being a single pinion planetary gear set and a second planetary gear set being a double pinion planetary gear set and having a ring gear and a planet carrier in common, wherein the first rotation element is a first sun gear, the second rotation element is a common planet carrier, the third rotation element is a common ring gear, and the fourth rotation element is a second sun gear.

Another exemplary compound planetary gear set may be formed by combining first and second planetary gear sets being double pinion planetary gear sets, wherein the first rotation element is a first sun gear, the second rotation element is a first ring gear and a second planet carrier, the third rotation element is a first planet carrier and a second ring gear, and the fourth rotation element is a second sun gear.

Other exemplary compound planetary gear sets may be formed by combining first and second planetary gear sets being single pinion planetary gear sets, wherein the first rotation element is a first sun gear, the second rotation element is a first planet carrier and a second ring gear, the third rotation element is a first ring gear and a second planet carrier, the fourth rotation element is a second sun gear.

A planetary gear train of an automatic transmission for a vehicle according to another aspect of the present disclosure may include: a first shaft receiving a torque of an engine; a second shaft disposed substantially in parallel with the first shaft at a predetermined distance; a compound planetary gear set formed by combining a first planetary gear set being a single pinion planetary gear set and a second planetary gear set being a double pinion planetary gear set and having a ring gear and a planet carrier in common, including a first rotation element being a first sun gear, a second rotation element being a common planet carrier, a third rotation element being a common ring gear, and a fourth rotation element being a second sun gear, and the compound planetary gear set disposed on the second shaft; a first transfer gear connecting the first shaft to the first rotation element and the fourth rotation element; a second transfer gear connecting the first shaft to the first rotation element and the second rotation element; a first clutch disposed between the first transfer gear and the fourth rotation element; a second clutch disposed between the first transfer gear and the first rotation element; a third clutch disposed between the second transfer gear and the first rotation element; a fourth clutch disposed between the second transfer gear and the second rotation element; a first brake disposed between the second rotation element and the transmission housing; and a second brake disposed between the first rotation element and the transmission housing.

A planetary gear train of an automatic transmission for a vehicle according to another aspect of the present disclosure may include: a first shaft receiving a torque of an engine; a second shaft disposed substantially in parallel with the first shaft at a predetermined distance; a compound planetary gear set formed by combining first and second planetary gear sets being double pinion planetary gear sets, including a first rotation element being a first sun gear, a second rotation element being a first ring gear and a second planet carrier, a third rotation element being a first planet carrier and a second ring gear, and a fourth rotation element being a second sun gear, and the compound planetary gear set disposed on the second shaft; a first transfer gear connecting the first shaft to the first rotation element and the fourth rotation element; a second transfer gear connecting the first shaft to the first rotation element and the second rotation element; a first clutch disposed between the first transfer gear and the fourth rotation element; a second clutch disposed between the first transfer gear and the first rotation element; a third clutch disposed between the second transfer gear and the first rotation element; a fourth clutch disposed between the second transfer gear and the second rotation element; a first brake disposed between the second rotation element and the transmission housing; and a second brake disposed between the first rotation element and the transmission housing.

A planetary gear train of an automatic transmission for a vehicle according to other aspects of the present disclosure may include: a first shaft receiving a torque of an engine; a second shaft disposed in parallel with the first shaft at a predetermined distance; a compound planetary gear set formed by combining first and second planetary gear sets being single pinion planetary gear sets, including a first rotation element being a first sun gear, a second rotation element being a first planet carrier and a second ring gear, a third rotation element being a first ring gear and a second planet carrier, and a fourth rotation element being a second sun gear, and the compound planetary gear set disposed on the second shaft; a first transfer gear connecting the first shaft to the first rotation element and the fourth rotation element; a second transfer gear connecting the first shaft to the first rotation element and the second rotation element; a first clutch disposed between the first transfer gear and the fourth rotation element; a second clutch disposed between the first transfer gear and the first rotation element; a third clutch disposed between the second transfer gear and the first rotation element; a fourth clutch disposed between the second transfer gear and the second rotation element; a first brake disposed between the second rotation element and the transmission housing; and a second brake disposed between the first rotation element and the transmission housing.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary planetary gear train according to the present disclosure.

FIG. 2 is an operational chart of friction elements at each shift-speed applied to the first exemplary planetary gear train according to the present disclosure.

FIG. 3 is a lever diagram of the exemplary planetary gear train of FIG. 1.

FIG. 4 is a schematic diagram of an exemplary planetary gear train according to the present disclosure.

FIG. 5 is a schematic diagram of an exemplary planetary gear train according to the present disclosure.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

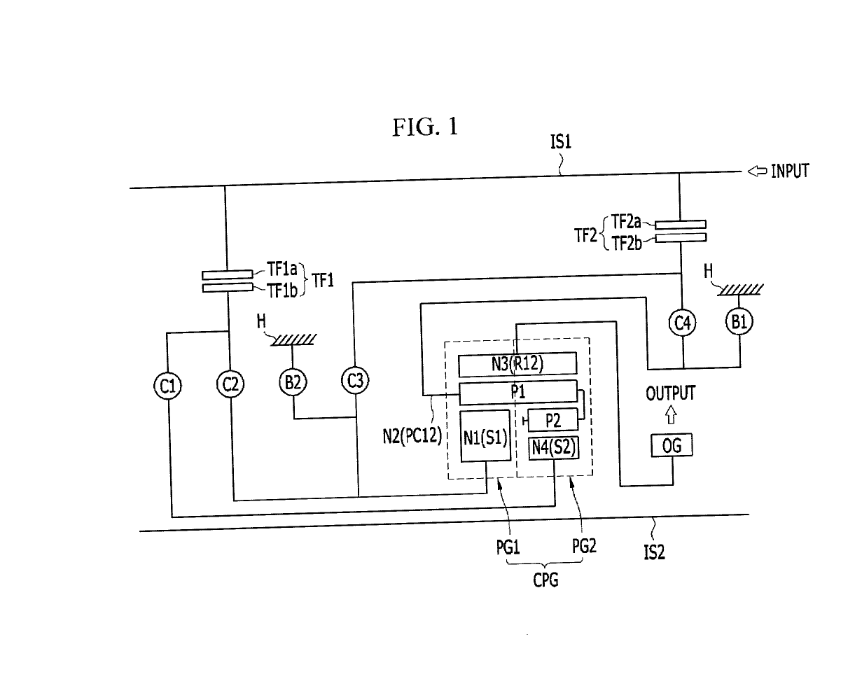

FIG. 1 is a schematic diagram of a planetary gear train according to various embodiments of the present disclosure. Referring to FIG. 1, a planetary gear train according to various embodiments of the present disclosure includes a first shaft IS1 and a second shaft IS2 disposed in parallel or substantially in parallel with each other with a predetermined distance, a compound planetary gear set CPG disposed on the second shaft IS2, two transfer gears TF1 and TF2, and frictional elements including four clutches C1, C2, C3, and C4 and two brakes B1 and B2.

Therefore, torque input from the first shaft IS1 is converted into eight forward speeds and two reverse speeds by operation of two transfer gears TF1 and TF2 and the compound planetary gear set CPG, and then is output through an output gear OG.

The first shaft IS1 is an input member, and torque from a crankshaft of the engine is changed through a torque converter and is input to the first shaft IS1. The second shaft IS2 supports the compound planetary gear set CPG without rotational interference therebetween.

The compound planetary gear set CPG is formed by combining a first planetary gear set PG1 being a single pinion planetary gear set and a second planetary gear set PG2 being a double pinion planetary gear set so as to be the compound planetary gear set of Ravingneaux type having a ring gear and a planet carrier in common.

For ease of description, the ring gear of the compound planetary gear set CPG is represented by a common ring gear R12, the planet carrier of the compound planetary gear set CPG is represented by a common planet carrier PC12, a sun gear engaged with a long pinion P1 is represented by a first sun gear S1, and a sun gear engaged with a short pinion P2 is represented by a second sun gear S2. In this case, the compound planetary gear set CPG includes a first rotation element N1 being the first sun gear S1, a second rotation element N2 being the common planet carrier PC 12, a third rotation element N3 being the common ring gear R12, and a fourth rotation element N4 being the second sun gear S2.

The third rotation element N3 is an output element and is connected to the output gear OG. The first, second, and fourth rotation elements N1, N2, and N4 are selectively connected to the first shaft IS1 and the transmission housing H through two transfer gears TF1 and TF2 and six frictional elements C1, C2, C3, C4, B1, and B2.

The first and second transfer gears TF1 and TF2 respectively have first and second transfer drive gears TF1a and TF2a and first and second transfer driven gears TF1b and TF2b externally meshed with each other.

The first transfer gear TF1 is arranged to deliver torque of the first shaft IS1 to the first rotation element N1 and the fourth rotation element N4. The second transfer gear TF2 is arranged to deliver the torque of the first shaft IS1 to the first rotation element N1 and the second rotation element N2.

Therefore, the rotation elements connected to the first shaft IS1 through the first and second transfer gears TF1 and TF2 are rotated in an opposite direction to a rotation direction of the first shaft IS1 according to gear ratios.

In addition, the frictional elements including four clutches C1, C2, C3, and C4 and two brakes B1 and B2 that connect the first shaft IS1 or the transmission housing H with the selected rotation elements are disposed as follows.

The first clutch C1 is disposed between the first transfer gear TF1 and the fourth rotation element N4 and is adapted to selectively deliver the torque of the first shaft IS1 to the fourth rotation element N4.

The second clutch C2 is disposed between the first transfer gear TF1 and the first rotation element N1 and is adapted to selectively deliver the torque of the first shaft IS1 to the first rotation element N1.

The third clutch C3 is disposed between the second transfer gear TF2 and the first rotation element N1 and is adapted to selectively deliver the torque of the first shaft IS1 to the first rotation element N1.

The fourth clutch C4 is disposed between the second transfer gear TF2 and the second rotation element N2 and is adapted to selectively deliver the torque of the first shaft IS1 to the second rotation element N2.

The first brake B1 is disposed between the second rotation element N2 and the transmission housing H and is adapted to cause the second rotation element N2 to be selectively operated as a fixed element.

The second brake B2 is disposed between the first rotation element N1 and the transmission housing H and is adapted to cause the first rotation element N1 to be selectively operated as a fixed element.

Both of the second clutch C2 and the third clutch C3 selectively connect the first shaft IS1 to the first rotation element N1. Since a gear ratio of the first transfer gear TF1 differs from that of the second transfer gear TF2, however, rotation speeds delivered to the first rotation element N1 through the second clutch C2 and the third clutch C3 are different from each other.

In addition, the friction elements consisting of the first, second, third, and fourth clutches C1, C2, C3, and C4 and the first and second brakes B1 and B2 are conventional multi-plate friction elements of wet type that are operated by hydraulic pressure.

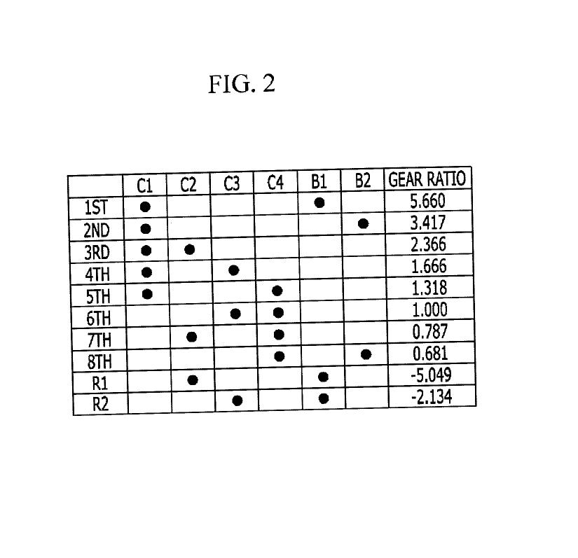

FIG. 2 is an operational chart of friction elements at each shift-speed applied to a planetary gear train according to various embodiments of the present disclosure. As shown in FIG. 2, two frictional elements are operated at each shift-speed in the planetary gear train according to various embodiments of the present disclosure.

A first forward speed 1ST is achieved by operating the first clutch C1 and the first brake B1. A second forward speed 2ND is achieved by operating the first clutch C1 and the second brake B2. A third forward speed 3RD is achieved by operating the first clutch C1 and the second clutch C2. A fourth forward speed 4TH is achieved by operating the first clutch C1 and the third clutch C3. A fifth forward speed 5TH is achieved by operating the first clutch C1 and the fourth clutch C4. A sixth forward speed 6TH is achieved by operating the third clutch C3 and the fourth clutch C4. A seventh forward speed 7TH is achieved by operating the second clutch C2 and the fourth clutch C4. An eighth forward speed 8TH is achieved by operating the fourth clutch C4 and the second brake B2.

A first reverse speed R1 is achieved by operating the second clutch C2 and the first brake B1. A second reverse speed R2 is achieved by operating the third clutch C3 and the first brake B1.

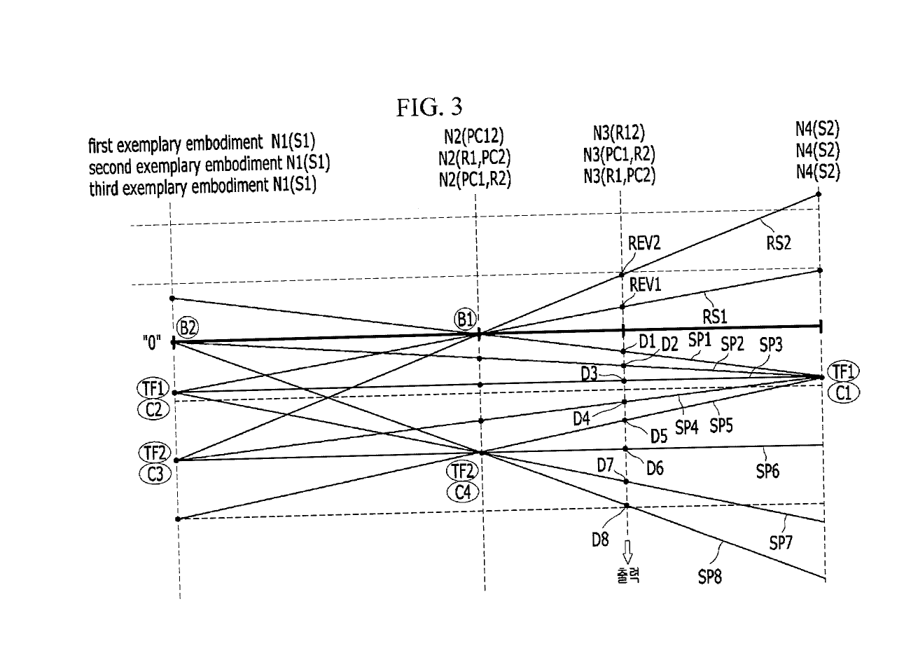

FIG. 3 is a lever diagram of a planetary gear train according to various embodiments of the present disclosure, and illustrates shift processes of the planetary gear train according to the various embodiments of the present disclosure by lever analysis method.

Referring to FIG. 3, four vertical lines are set as the first, second, third, and fourth rotation elements N1, N2, N3, and N4 from the left to the right, a middle horizontal line represents a rotation speed of “0”, upper horizontal lines represent positive rotation speeds and lower horizontal lines represent negative rotation speeds.

In addition, “-” in FIG. 3 means that rotational elements are rotated in an opposite direction to the rotation direction of the engine. It is because the first shaft IS1 and the compound planetary gear set CPG are externally meshed through the first and second transfer gears TF1 and TF2 without an idling gear.

In addition, distances between the vertical lines of the compound planetary gear set CPG are set approximately according to gear ratios (teeth number of a sun gear/teeth number of a ring gear).

Hereinafter, referring to FIG. 2 and FIG. 3, the shift processes of the planetary gear train according to the various embodiments of the present disclosure will be described in detail.

### First Forward Speed

Referring to FIG. 2, the first clutch C1 and the first brake B1 are operated at the first forward speed 1ST. As shown in FIG. 3, the torque of the first shaft IS1 is converted according to the gear ratio of the first transfer gear TF1 by operation of the first clutch C1 and is then input to the fourth rotation element N4 as an inverse rotation speed. In addition, the second rotation element N2 is operated as a fixed element by operation of the first brake B1. Therefore, the rotation elements of the compound planetary gear set CPG form a first shift line SP1, and D1 is output through the third rotation element N3 that is the output element.

### Second Forward Speed

The first brake B1 that was operated at the first forward speed 1ST is released and the second brake B2 is operated at the second forward speed 2ND. As shown in FIG. 3, the torque of the first shaft IS1 is converted according to the gear ratio of the first transfer gear TF1 by operation of the first clutch C1 and is then input to the fourth rotation element N4 as an inverse rotation speed. In addition, the first rotation element N1 is operated as a fixed element by operation of the second brake B2. Therefore, the rotation elements of compound planetary gear set CPG form a second shift line SP2, and D2 is output through the third rotation element N3 that is the output element.

### Third Forward Speed

The second brake B2 that was operated at the second forward speed 2ND is released and the second clutch C2 is operated at the third forward speed 3RD. As shown in FIG. 3, the torque of the first shaft IS1 is converted according to the gear ratio of the first transfer gear TF1 by operation of the first clutch C1 and is then input to the fourth rotation element N4 as an inverse rotation speed. In addition, the torque of the first shaft IS1 is converted according to the gear ratio of the first transfer gear TF1 by operation of the second clutch C2 and is then input to the first rotation element N1 as an inverse rotation speed.

That is, a rotation speed of the first shaft IS1 is changed according to the gear ratio of the first transfer gear TF1 and is input simultaneously to the first rotation element N1 and the fourth rotation element N4. Therefore, the rotation elements of the compound planetary gear set CPG form a third shift line SP3, and D3 is output through the third rotation element N3 that is the output element.

### Fourth Forward Speed

The second clutch C2 that was operated at the third forward speed 3RD is released and the third clutch C3 is operated at the fourth forward speed 4TH. As shown in FIG. 3, the torque of the first shaft IS1 is converted according to the gear ratio of the first transfer gear TF1 by operation of the first clutch C1 and is then input to the fourth rotation element N4 as an inverse rotation speed. In addition, the torque of the first shaft IS1 is converted according to the gear ratio of the second transfer gear TF2 by operation of the third clutch C3 and is then input to the first rotation element N1 as an inverse rotation speed. Therefore, the rotation elements of the compound planetary gear set CPG form a fourth shift line SP4, and D4 is output through the third rotation element N3 that is the output element.

### Fifth Forward Speed

The third clutch C3 that was operated at the fourth forward speed 4TH is released and the fourth clutch C4 is operated at the fifth forward speed 5TH. As shown in FIG. 3, the torque of the first shaft IS1 is converted according to the gear ratio of the first transfer gear TF1 by operation of the first clutch C1 and is then input to the fourth rotation element N4 as an inverse rotation speed. In addition, the torque of the first shaft IS1 is converted according to the gear ratio of the second transfer gear TF2 by operation of the fourth clutch C4 and is then input to the second rotation element N2 as an inverse rotation speed. Therefore, the rotation elements of the compound planetary gear set CPG form a fifth shift line SP5, and D5 is output through the third rotation element N3 that is the output element.

### Sixth Forward Speed

The first clutch C1 that was operated at the fifth forward speed 5TH is released and the third clutch C3 is operated at the sixth forward speed 6TH. As shown in FIG. 3, the torque of the first shaft IS1 is converted according to the gear ratio of the second transfer gear TF2 by operation of the third clutch C3 and is then input to the first rotation element N1 as an inverse rotation speed. In addition, the torque of the first shaft IS1 is converted according to the gear ratio of the second transfer gear TF2 by operation of the fourth clutch C4 and is then input to the second rotation element N2 as an inverse rotation speed.

That is, the rotation speed of the first shaft IS1 is changed according to the gear ratio of the second transfer gear TF2 and is then input simultaneously to the first rotation element N1 and the second rotation element N2. Therefore, the rotation elements of the compound planetary gear set CPG form a sixth shift line SP6, and D6 is output through the third rotation element N3 that is the output element.

### Seventh Forward Speed

The third clutch C3 that was operated at the sixth forward speed 6TH is released and the second clutch C2 is operated the seventh forward speed 7TH. As shown in FIG. 3, the torque of the first shaft IS1 is converted according to the gear ratio of the second transfer gear TF2 by operation of the fourth clutch C4 and is then input to the second rotation element N2 as an inverse rotation speed. In addition, the torque of the first shaft IS1 is converted according to the gear ratio of the first transfer gear TF1 by operation of the second clutch C2 and is then input to the first rotation element N1 as an inverse rotation speed. Therefore, the rotation elements of the compound planetary gear set CPG form a seventh shift line SP7, and D7 is output through the third rotation element N3 that is the output element.

### Eighth Forward Speed

The second clutch C2 that was operated at the seventh forward speed 7TH is released and the second brake B2 is operated at the eighth forward speed 8TH. As shown in FIG. 3, the torque of the first shaft IS1 is converted according to the gear ratio of the second transfer gear TF2 by operation of the fourth clutch C4 and is then input to the second rotation element N2 as an inverse rotation speed. In addition, the first rotation element N1 is operated as a fixed element by operation of the second brake B2. Therefore, the rotation elements of the compound planetary gear set CPG form an eighth shift line SP8, and D8 is output through the third rotation element N3 that is the output element.

### First Reverse Speed

As shown in FIG. 2, the second clutch C2 and the first brake B1 are operated at the first reverse speed R1. As shown in FIG. 3, the torque of the first shaft IS1 is converted according to the gear ratio of the first transfer gear TF1 by operation of the second clutch C2 and is then input to the first rotation element N1 as an inverse rotation speed. In addition, the second rotation element N2 is operated as a fixed element by operation of the first brake B1. Therefore, the rotation elements of the compound planetary gear set CPG form a first reverse speed line RS1, and REV1 is output through the third rotation element N3 that is the output element.

### Second Reverse Speed

As shown in FIG. 2, the third clutch C3 and the first brake B1 are operated at the second reverse speed R2. As shown in FIG. 3, the torque of the first shaft IS1 is converted according to the gear ratio of the second transfer gear TF2 by operation of the third clutch C3 and is then input to the first rotation element N1 as an inverse rotation speed. In addition, the second rotation element N2 is operated as a fixed element by operation of the first brake B1. Therefore, the rotation elements of the compound planetary gear set CPG form a second reverse speed line RS2, and REV2 is output through the third rotation element N3 that is the output element.

As described above, the planetary gear train according to various embodiments of the present disclosure can achieve eight forward speeds and two reverse speeds by combining one compound planetary gear set CPG, two transfer gears TF1 and TF2 and six frictional elements C1, C2, C3, C4, B1, and B2.

In addition, optimum gear ratios may be set due to ease of changing gear ratios by using two external-meshing gears as well as the planetary gear sets. Since gear ratios can be changed according to target performance, starting performance, power delivery performance, and fuel economy may be improved. Therefore, a start-up clutch instead of a torque converter may be used.

In addition, since two reverse speeds are achieved, performance in reverse speeds may be improved. In addition, two friction elements are operated at each shift-speed and one friction element is released and another friction element is operated so as to shift to a neighboring shift-speed. Therefore, shift control condition is fully satisfied.

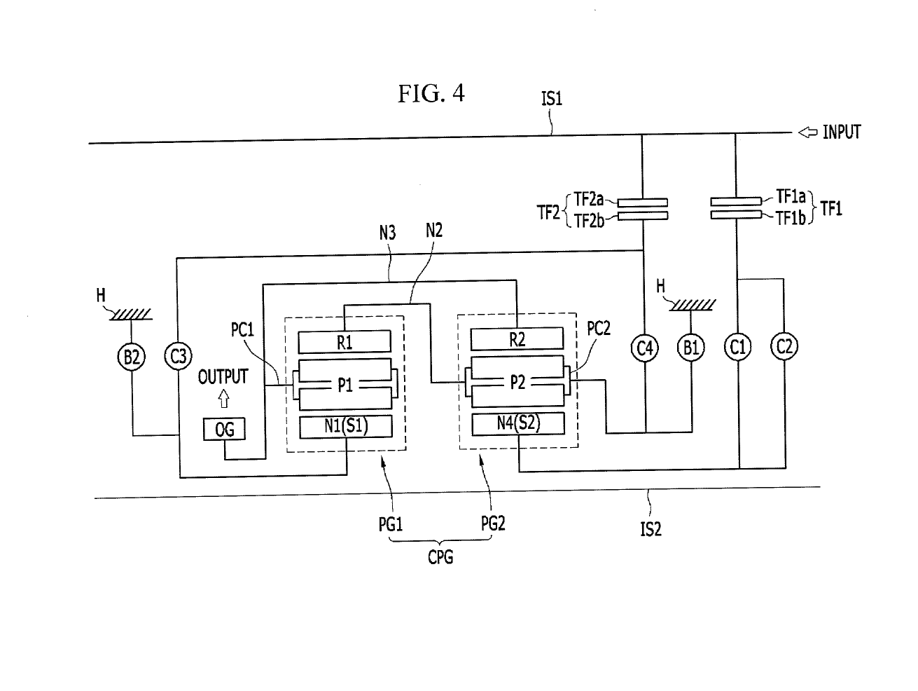

FIG. 4 is a schematic diagram of a planetary gear train according to various embodiments of the present disclosure. Referring to FIG. 4, the compound planetary gear set CPG is formed by combining the first planetary gear set PG1 being the single pinion planetary gear set and the second planetary gear set PG2 being the double pinion planetary gear set described above, but the compound planetary gear set CPG is formed by combining the first and second planetary gear sets PG1 and PG2 being double pinion planetary gear sets.

Therefore, the first rotation element N1 is the first sun gear S1, the second rotation element N2 is the first ring gear R1 and the second planet carrier PC2, the third rotation element N3 is the first planet carrier PC1 and the second ring gear R2, and the fourth rotation element N4 is the second sun gear S2.

Since functions of these embodiments are the same as that described above except rotation elements consisting of the second and third rotation elements N2 and N3, description in the context of the embodiments described above applies to these embodiments.

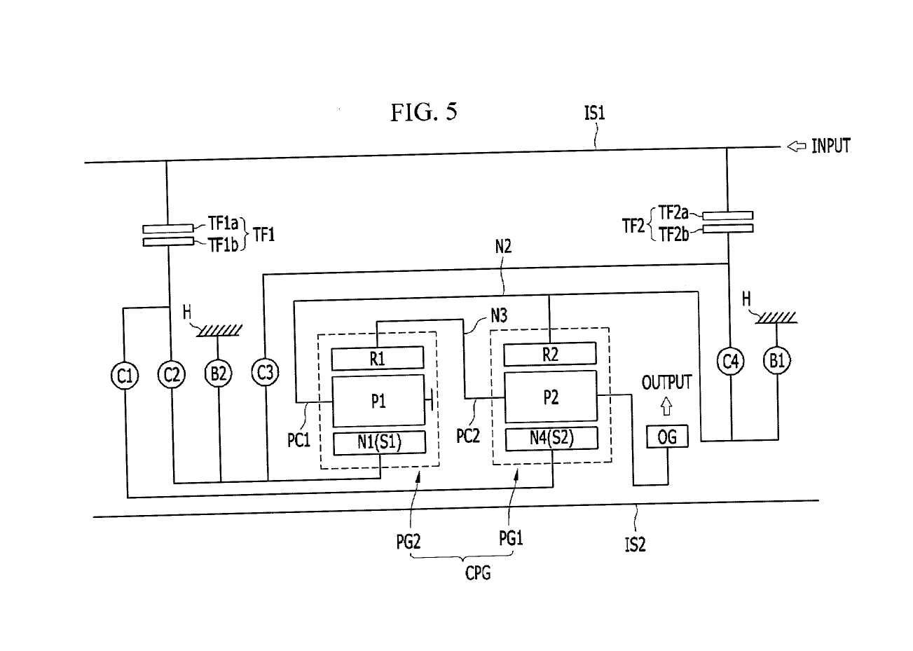

FIG. 5 is a schematic diagram of a planetary gear train according to various embodiments of the present disclosure. Referring to FIG. 5, the compound planetary gear set CPG is formed by combining the first planetary gear set PG1 being the single pinion planetary gear set and the second planetary gear set PG2 being the double pinion planetary gear set in the above described embodiments, but the compound planetary gear set CPG is formed by combining the first and second planetary gear sets PG1 and PG2 being single pinion planetary gear sets.

Therefore, the first rotation element N1 is the first sun gear S1, the second rotation element N2 is the first planet carrier PC1 and the second ring gear R2, the third rotation element N3 is the first ring gear R1 and the second planet carrier PC2, and the fourth rotation element N4 is the second sun gear S2.

Since functions of these embodiments are the same as those described above except the rotation elements consisting of the second and third rotation elements N2 and N3, description in the context of the above described embodiments applies to these embodiments.

Meanwhile, it is illustrated, but is not limited, in the drawings that the second shaft IS2 merely supports the compound planetary gear set CPG without rotational interference therebetween. That is, the second shaft IS2 may be directly connected to the third rotation element N3 that is the output element so as to be operated as an output shaft. In addition, the second shaft IS2 may be used as a connecting member that connects the rotation elements.

Eight forward speeds and two reverse speeds can be achieve by combining one compound planetary gear set consisting of simple planetary gear sets, two transfer gears and six frictional elements according to various embodiments of the present disclosure.

In addition, since one compound planetary gear set is disposed on the second shaft disposed in parallel or substantially in parallel with the first shaft that is the input shaft and is connected to the first shaft through the transfer gears that is the externally-meshed gears, a length thereof may be reduced and mountability may be improved.

In addition, optimum gear ratios may be set due to ease of changing gear ratios by using two external-meshing gears as well as the planetary gear sets. Since gear ratios can be changed according to target performance, starting performance, power delivery performance, and fuel economy may be improved. Therefore, a start-up clutch instead of a torque converter may be used.

In addition, since two reverse speeds is achieved, performance in reverse speeds may be improved. In addition, two friction elements are operated at each shift-speed, and one friction element is released and another friction element is operated so as to shift to a neighboring shift-speed. Therefore, shift control condition is fully satisfied.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A planetary gear train of an automatic transmission for a vehicle, comprising:
a first shaft receiving a torque of an engine;
a second shaft disposed substantially in parallel with the first shaft at a predetermined distance;
a compound planetary gear set disposed on the second shaft, and including a first rotation element selectively connected to the first shaft through two paths and operated as a first selective fixed element, a second rotation element selectively connected to the first shaft through one path and operated as a second selective fixed element, a third rotation element operated as an output element, and a fourth rotation element selectively connected to the first shaft through one path;
two transfer gears interposed at connecting portions between the rotation elements of the compound planetary gear set and the first shaft; and
frictional elements including clutches selectively connecting the first, second, and fourth rotation elements to the first shaft and brakes selectively connecting the first and second rotation elements to a transmission housing.

2. The planetary gear train of claim 1, wherein the compound planetary gear set is formed by combining a first planetary gear set being a single pinion planetary gear set and a second planetary gear set being a double pinion planetary gear set and having a ring gear and a planet carrier in common, and
the first rotation element is a first sun gear, the second rotation element is a common planet carrier, the third rotation element is a common ring gear, and the fourth rotation element is a second sun gear.

3. The planetary gear train of claim 1, wherein the two transfer gears comprise:
a first transfer gear connecting the first shaft to the first rotation element and the fourth rotation element; and
a second transfer gear connecting the first shaft to the first rotation element and the second rotation element.

4. The planetary gear train of claim 3, wherein the frictional elements comprise:
a first clutch disposed between the first transfer gear and the fourth rotation element;
a second clutch disposed between the first transfer gear and the first rotation element;
a third clutch disposed between the second transfer gear and the first rotation element;
a fourth clutch disposed between the second transfer gear and the second rotation element;
a first brake disposed between the second rotation element and the transmission housing; and
a second brake disposed between the first rotation element and the transmission housing.

5. The planetary gear train of claim 4, wherein a first forward speed is achieved by operating the first clutch and the first brake,
a second forward speed is achieved by operating the first clutch and the second brake,
a third forward speed is achieved by operating the first clutch and the second clutch,
a fourth forward speed is achieved by operating the first clutch and the third clutch,
a fifth forward speed is achieved by operating the first clutch and the fourth clutch,
a sixth forward speed is achieved by operating the third clutch and the fourth clutch,
a seventh forward speed is achieved by operating the second clutch and the fourth clutch,
an eighth forward speed is achieved by operating the fourth clutch and the second brake,
a first reverse speed is achieved by operating the second clutch and the first brake, and
a second reverse speed is achieved by operating the third clutch and the first brake.

6. The planetary gear train of claim 1, wherein the compound planetary gear set is formed by combining first and second planetary gear sets being double pinion planetary gear sets, and
the first rotation element is a first sun gear, the second rotation element is a first ring gear and a second planet carrier, the third rotation element is a first planet carrier and a second ring gear, and the fourth rotation element is a second sun gear.

7. The planetary gear train of claim 1, wherein the compound planetary gear set is formed by combining first and second planetary gear sets being single pinion planetary gear sets, and
the first rotation element is a first sun gear, the second rotation element is a first planet carrier and a second ring gear, the third rotation element is a first ring gear and a second planet carrier, the fourth rotation element is a second sun gear.

8. A planetary gear train of an automatic transmission for a vehicle, comprising:
a first shaft receiving a torque of an engine;
a second shaft disposed substantially in parallel with the first shaft at a predetermined distance;
a compound planetary gear set formed by combining a first planetary gear set being a single pinion planetary gear set and a second planetary gear set being a double pinion planetary gear set and having a ring gear and a planet carrier in common, including a first rotation element being a first sun gear, a second rotation element being a common planet carrier, a third rotation element being a common ring gear, and a fourth rotation element being a second sun gear, and the compound planetary gear set disposed on the second shaft;
a first transfer gear connecting the first shaft to the first rotation element and the fourth rotation element;
a second transfer gear connecting the first shaft to the first rotation element and the second rotation element;
a first clutch disposed between the first transfer gear and the fourth rotation element;
a second clutch disposed between the first transfer gear and the first rotation element;
a third clutch disposed between the second transfer gear and the first rotation element;
a fourth clutch disposed between the second transfer gear and the second rotation element;
a first brake disposed between the second rotation element and the transmission housing; and
a second brake disposed between the first rotation element and the transmission housing.

9. A planetary gear train of an automatic transmission for a vehicle, comprising:
a first shaft receiving a torque of an engine;
a second shaft disposed substantially in parallel with the first shaft at a predetermined distance;
a compound planetary gear set formed by combining first and second planetary gear sets being double pinion planetary gear sets, including a first rotation element being a first sun gear, a second rotation element being a first ring gear and a second planet carrier, a third rotation element being a first planet carrier and a second ring gear, and a fourth rotation element being a second sun gear, and the compound planetary gear set disposed on the second shaft;
a first transfer gear connecting the first shaft to the first rotation element and the fourth rotation element;
a second transfer gear connecting the first shaft to the first rotation element and the second rotation element;
a first clutch disposed between the first transfer gear and the fourth rotation element;
a second clutch disposed between the first transfer gear and the first rotation element;
a third clutch disposed between the second transfer gear and the first rotation element;
a fourth clutch disposed between the second transfer gear and the second rotation element;
a first brake disposed between the second rotation element and the transmission housing; and
a second brake disposed between the first rotation element and the transmission housing.

10. A planetary gear train of an automatic transmission for a vehicle, comprising:
a first shaft receiving a torque of an engine;
a second shaft disposed substantially in parallel with the first shaft at a predetermined distance;
a compound planetary gear set formed by combining first and second planetary gear sets being single pinion planetary gear sets, including a first rotation element being a first sun gear, a second rotation element being a first planet carrier and a second ring gear, a third rotation element being a first ring gear and a second planet carrier, and a fourth rotation element being a second sun gear, and compound planetary gear set disposed on the second shaft;
a first transfer gear connecting the first shaft to the first rotation element and the fourth rotation element;
a second transfer gear connecting the first shaft to the first rotation element and the second rotation element;
a first clutch disposed between the first transfer gear and the fourth rotation element;
a second clutch disposed between the first transfer gear and the first rotation element;
a third clutch disposed between the second transfer gear and the first rotation element;
a fourth clutch disposed between the second transfer gear and the second rotation element;
a first brake disposed between the second rotation element and the transmission housing; and
a second brake disposed between the first rotation element and the transmission housing.
